(19) United States
(12) Patent Application Publication
(10) Pub. No.: US 2009/0079703 A1
(43) Pub. Date: Mar. 26, 2009

(54) DEVICE AND SYSTEM FOR PROVIDING USER WITH SENSATION EFFECT ON TOUCH SCREEN

(75) Inventors: Ki-Uk KYUNG, Daejon (KR); Jun-Young LEE, Daejon (KR); Ji-Yeon SON, Daejon (KR); Jun-Seok PARK, Daejon (KR); Chang-Seok BAE, Daejon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejon (KR)

(21) Appl. No.: 12/137,706

(22) Filed: Jun. 12, 2008

(30) Foreign Application Priority Data
Sep. 20, 2007 (KR) 10-2007-0095746

(51) Int. Cl. G06F 3/041

(52) U.S. Cl. 345/173

(57) ABSTRACT

Provided is a device and system for providing a user with a sensation effect on touch screen. The device includes a sensation effect creating unit for creating sensation effect based on motion information of the input device; a communication unit for communicating with the display device; a control unit for creating sensation effect through the sensation effect creating unit when the motion information of the input device and sensation effect data according to an input mode are transmitted from the display device through the communication unit.

### CROSS-REFERENCE(S) TO RELATED APPLICATIONS

The present invention claims priority of Korean Patent Application No. 10-2007-0095746, filed on Sep. 20, 2007, which is incorporated herein by reference.

### BACKGROUND OF THE INVENTION

1. Field of the Invention

The present invention relates to a device and system for providing a user with a sensation effect on touch screen; and, more particularly, to a sensation effect providing device and system for providing reality by realizing senses of touch, hearing, and smell on motions of an input device when a user uses a pen-type input device in a computer or a terminal embedded with a touch screen.

2. Description of Related Art

In a conventional display device embedded with a touch screen, a user can write or draw whatever by using a pen-type input device and feels special tactile sense on touch screen such as a feeling generated when the input device slides on Liquid Crystal Display (LCD). Therefore, the user cannot feel the sense of real such as writing on paper with a pen.

According to Korean Patent which is related to a computer device for early childhood education, a vibration device is equipped with an electronic pen used as the input device such that a child can feel tactile sense. However, the computer device provides vibration only through predetermined contents but does not provide tactile sense through user's action, i.e., motions such as writing or drawing.

### SUMMARY OF THE INVENTION

An embodiment of the present invention is directed to providing a sensation effect providing device and system for providing reality by realizing senses of touch, hearing, and smell on motions of an input device in addition to a simple illustration function when a user uses a pen-type input device in a computer or a terminal embedded with a touch screen.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an aspect of the present invention, there is provided an input device which is used with a touch screen embedded with a display device, including: a sensation effect creating unit for creating sensation effect based on motion information of the input device; a communication unit for communicating with the display device; a control unit for creating sensation effect through the sensation effect creating unit when the motion information of the input device and sensation effect data according to an input mode are transmitted from the display device through the communication unit.

In accordance with another aspect of the present invention, there is provided a display device including a touch screen used with an input device providing a user with a sensation effect, including: a memory for storing sensation effect data according to an input mode of the input device; a communication unit for communicating with the input device; and a control unit for reading the sensation effect data in the memory on motion information of the input device when the input mode is set up and transmitting the sensation effect data to the input device through the communication unit.

In accordance with another aspect of the present invention, there is provided a a system for providing a user with a sensation effect, including: an input device, including a sensation effect creating unit for creating sensation effect based on motion information of the input device; a communication unit for communicating with a display device; and a control unit creating sensation effect through the sensation effect creating unit when the motion information of the input device and the sensation effect data according to the input mode are transmitted from the display device through the communication unit, and a display device, including a memory for storing sensation effect data according to an input mode of the input device; a communication unit for communicating with the input device; and a control unit for reading sensation effect data in the memory when the input mode is set up, and transmitting the sensation effect data to input device through the communication unit.

### BRIEF DESCRIPTION OF THE DRAWINGS

FIG. 1 is a block diagram showing a sensation effect providing system where the present invention is applied 1.

FIG. 2 is a block diagram showing a display device in accordance with an embodiment of the present invention.

FIG. 3 is a block diagram showing an input device in accordance with an embodiment of the present invention.

FIG. 4 is a flowchart describing an information flow between the display device and the input device in accordance with an embodiment of the present invention.

FIG. 5 shows the input device in accordance with an embodiment of the present invention.

FIG. 6A shows a vibration generation device of the input device in accordance with an embodiment of the present invention.

FIG. 6B shows the vibration generation device of the input device in accordance with the embodiment of the present invention.

FIG. 7 shows a picture input screen in accordance with an embodiment of the present invention.

FIG. 8 shows a letter input screen in accordance with an embodiment of the present invention.

### DESCRIPTION OF SPECIFIC EMBODIMENTS

The advantages, features and aspects of the invention will become apparent from the following description of the embodiments with reference to the accompanying drawings, which is set forth hereinafter. Therefore, those skilled in the field of this art of the present invention can embody the technological concept and scope of the invention easily. In addition, if it is considered that detailed description on a related art may obscure the points of the present invention, the detailed description will not be provided herein. The preferred embodiments of the present invention will be described in detail hereinafter with reference to the attached drawings.

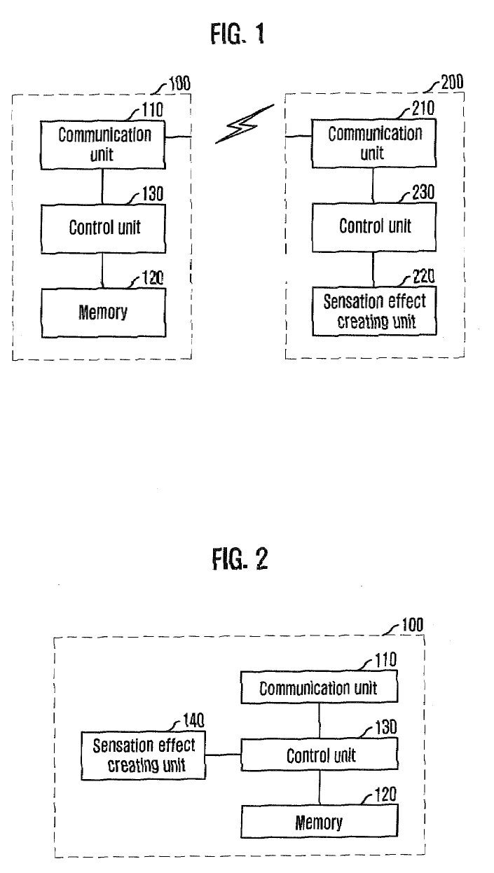

FIG. 1 is a block diagram showing a sensation effect providing system where the present invention is applied. As described above, a display device 100 includes a communication unit 110, a memory 120, and a control unit 130. The input device 200 includes a communication unit 210, a sensation effect creating unit 220, and a control unit 230.

The communication unit 110 of the display device 100 communicates with the input device 200 and transmits motion information and sensation effect data of the input device. The memory 120 stores sensation effect data on diverse input modes of the input device 200. The control unit 130 controls general operations of the communication unit 110 and the memory 120. The control unit 130 creates motion information by sensing the motion of the input device 200 on touch screen. When an input mode is selected, the control unit 130 reads sensation effect data corresponding to the input mode in the memory 120. Also, the control unit 130 transmits the motion information of the input device and the sensation effect data read in the memory to the input device 200 through the communication unit 110.

The communication unit 210 of the input device 200 communicates with the display device 100 and receives the motion information of the input device and the sensation effect data. The sensation effect creating unit 220 creates sensation effect through sensation effect data transmitted from the display device 100. When the input device moves, the motion information is transmitted from the display device. Therefore, the sensation effect creating unit 220 creates sensation effect according to the motion information based on the sensation effect data. The control unit 230 controls general operations of the communication unit 210 and the sensation effect creating unit 220. When the motion information and the sensation effect data according to the selected input mode are transmitted from the display device 100, the control unit 230 creates sensation effect through the sensation effect creating unit 220.

FIG. 2 is a block diagram showing the display device in accordance with an embodiment of the present invention and shows that the sensation effect creating unit is added to the display device of FIG. 1.

The communication unit 110 communicates with the input device 200 and transmits the motion information of the input device and the sensation effect data. The memory 120 stores the sensation effect data on diverse input modes of the input device 200. The sensation effect creating unit 140 creates sensation effect on an input mode selected by the motion of the input device.

The control unit 130 controls general operations of the communication unit 110, the memory 120, and the sensation effect creating unit 140. The control unit 130 creates motion information by sensing the motion of the input device 200 on touch screen. When an input mode is selected, the control unit 130 reads sensation effect data corresponding to the input mode in the memory 120. Also, the control unit 130 creates sensation effect by controlling the sensation effect creating unit 140 based on the motion information of the input device and the sensation effect data read in the memory.

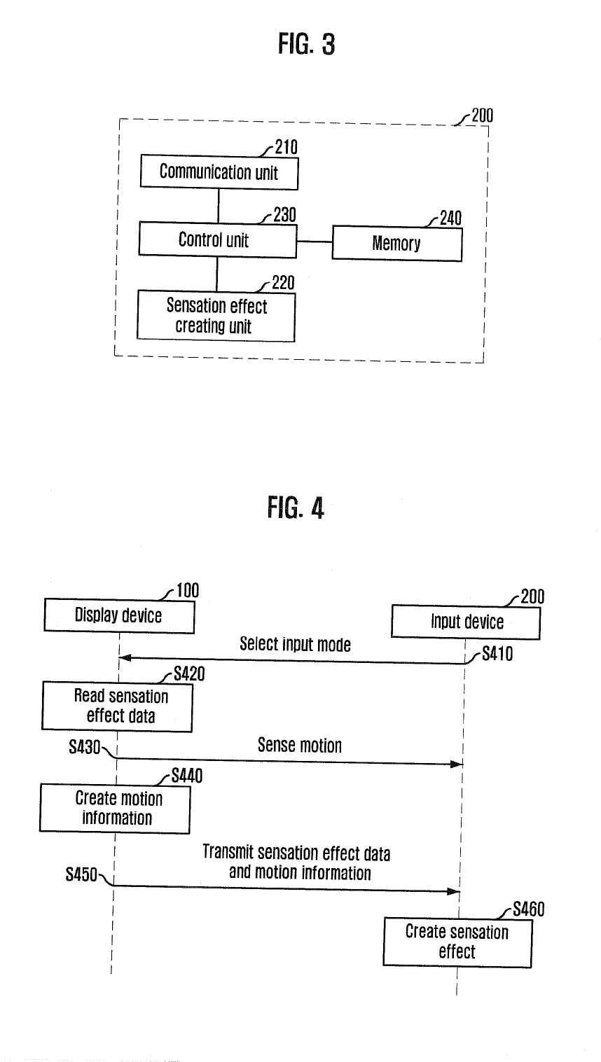

FIG. 3 is a block diagram showing the input device 200 in accordance with an embodiment of the present invention and shows that a memory 240 is added to the input device 200 of FIG. 1.

The communication unit 210 communicates with the display device 100 and receives motion information of the input device and the sensation effect data. The memory 240 stores sensation effect data according to an input mode. The sensation effect creating unit 220 creates sensation effect based on the sensation effect data read in the memory 240 according to the selected input mode. When the input device moves, the related motion information is transmitted from the display device. Therefore, the sensation effect creating unit 220 creates sensation effect by reading the sensation effect data in the memory based on the motion information.

The control unit 230 controls general operations of the communication unit 210, the sensation effect creating unit 220, and the memory 240. When the motion information is transmitted from the display device 100, the control unit 230 reads the sensation effect data in the memory 240 according to the selected input mode and creates sensation effect through the sensation effect creating unit 220.

FIG. 4 is a flowchart describing an information flow between the display device 100 and the input device 200 in accordance with an embodiment of the present invention.

The user selects an input mode of the input device 200 at step S410. A kind of writing instruments and a quality of a material for a background image may be selected as an input mode. The writing instruments are instruments generally used for writing or drawing such as a writing brush, a pen, a colored pencil, a stick, a pastel crayon, and marking ink. The background image is materials for drawing or writing such as soil, paper, plastic, glass and blackboard.

The control unit 130 of the display device 100 reads the sensation effect data corresponding to the selected input mode in the memory 120 at step S420. The sensation effect data include tactile sense data, acoustic sense data, and olfactory sense data. The tactile sense data means a feeling that the user contacts a surface having a predetermined quality of a material with a predetermined instrument.

The acoustic sense data means a sound generated when the user contacts a surface having a predetermined quality of a material with a predetermined instrument. The olfactory sense data means a specific fragrance that a predetermined instrument or a quality of a background material has. When the motion of the input device 200 is recognized as a letter or a shape meaning a specific fragrance, the olfactory sense data means a corresponding specific fragrance.

For example, when the writing brush and the paper are selected as the input mode, the control unit 130 reads tactile sense data such as flexible feeling of the writing brush and feeling of sliding on paper, acoustic sense data such as a sound that the writing brush grazes the paper, and olfactory sense data such as a fragrance that Chinese ink emits in the memory 120.

When a quality of a material corresponding to a predetermined region is set up as “unevenness”, the control unit 130 reads tactile data of uneven feeling in the memory 120. Also, when the information data mean a letter “apple” or a shape of the apple, the control unit 130 reads olfactory sense data of apple flavor in the memory 120.

When the motion of the input device 200 is sensed at step S430, the control unit 130 creates motion information at step S440, and transmits the sensation effect data and the motion information to the input device 200 at Step S450. The control unit 230 of the input device 200 creates sensation effect through the sensation effect creating unit 220 based on the sensation effect data and the motion information transmitted from the display device 100 at step S460.

For example, a stick and soil are selected as an input mode, the control unit 130 reads the sensation effect data in the memory 120. Subsequently, when the motion of the input device 200 is sensed, the control unit 130 creates motion information and transmits the sensation effect data and the motion information to the input device 200. When the control unit 230 of the input device 200 receives the sensation effect data and the motion information from the display device 100, the control unit 230 creates a rough feeling that the user draws on ground with the stick, a sound that the ground is scratched, and smell of soil.

According to the present invention, the display device 100 may include the sensation effect creating unit 140 as shown in FIG. 2. In this case, the control unit 130 of the display device 100 reads the sensation effect data corresponding to the input mode in the memory 120 and creates sensation effect through the sensation effect creating unit 140 based on the motion information and the sensation effect data. There are a speaker and a fragrance emitting module as examples of the sensation effect creating unit 140.

According to the present invention, the input device 200 may include the memory 240 as shown in FIG. 3. In this case, the control unit 230 of the input device 200 receives the motion information transmitted from the display device 100, reads the sensation effect data from the memory 240 according to the input mode, and creates the sensation effect through the sensation effect creating unit 220 based on the read sensation effect data.

For example, the control unit 230 of the input device 200 checks that a pen and paper are selected as the input mode based on the motion information transmitted from the display device 100 and reads the sensation effect data in the memory 240. Tactile sense data of feeling that a pen scratches on paper, acoustic sense data of a sound that the paper is scratched, and olfactory sense data of ink smell are read as sensation effect data in the memory 240.

The control unit 230 creates sensation effect through the sensation effect creating unit 220 based on the read sensation effect data. That is, the control unit 230 creates the tactile sense data of feeling that the pen scratches on paper, the acoustic sense data of the sound that the paper is scratched, and the olfactory sense data of ink smell. Accordingly, the user receives actual sensation effect generated when the user draws on paper with a pen.

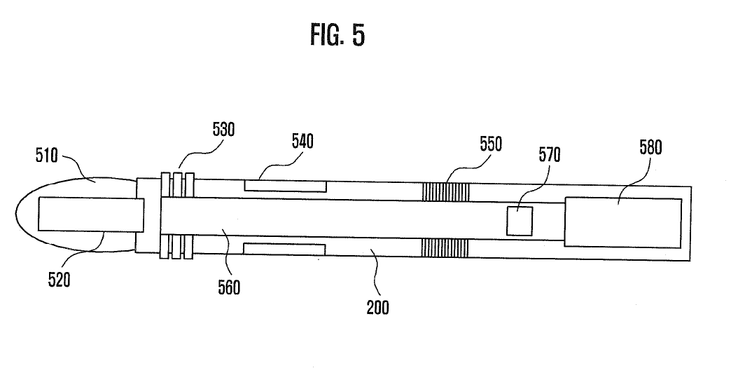

FIG. 5 shows the input device in accordance with an embodiment of the present invention. The input device 200 includes the sensation effect creating unit 220 including a control unit 560, a communication unit 570, and a battery 580. Also, the input device 200 includes a vibration generating device 520, a skin stimulating pin 530, a speaker 540 and a fragrance emitting module 550.

The sensation effect creating unit 220 for creating tactile sense includes the vibration generating device 520 and the skin stimulating pin 530 as an example. The vibration generating device 520 generates vibration by being positioned at a header part 510. The skin stimulating pin 530 is positioned at a grip part of the input device which is directly contacted to the skin of the user. The skin stimulating pin 530 may be formed of a plurality of pins capable of moving up and down.

Therefore, the skin of the user is stimulated by up and down movement of a plurality of pins. For example, when a stick and ground are selected as an input mode and motion information is created in a part that a picture are drawn on touch screen, tactile sense of a groove carved on ground is created by the up and down movement of the skin stimulating pin 530.

The sensation effect creating unit 220 for creating acoustic sense includes the speaker 540 as an example. The speaker 540 transmits actual feeling to the user by creating a sound corresponding to the acoustic sense data. For example, when a stick and ground are selected as the input mode, a sound that the stick scratches the ground is created through the speaker 540. When a pen and paper are selected as the input mode, a sound that the paper is scratched by the pen is created through the speaker 540.

The sensation effect creating unit 220 for creating olfactory sense may be the fragrance emitting module 550. The fragrance emitting module 550 is formed to be connected to the outside as a module having a plurality of fragrance sources. Therefore, the fragrance is emitted to outside based on the motion information. The fragrance emitting module 550 stores a designated specific fragrance source and emits fragrance of an object or a material defined by the user.

That is, unique fragrance of an instrument or a background material selected as the input mode and a specific fragrance that an inputted letter or shape means are emitted. For example, when soil is selected as the input mode, soil smell is emitted through the fragrance emitting module 550. When the motion information means a letter or a shape of “lemon”, a lemon favor is emitted. This function may be applied to a child education program. For example, when the shape of the apple is suggested to the display device 100 and a child paints the inside of the apple, it is programmed for an apple favor to be emitted.

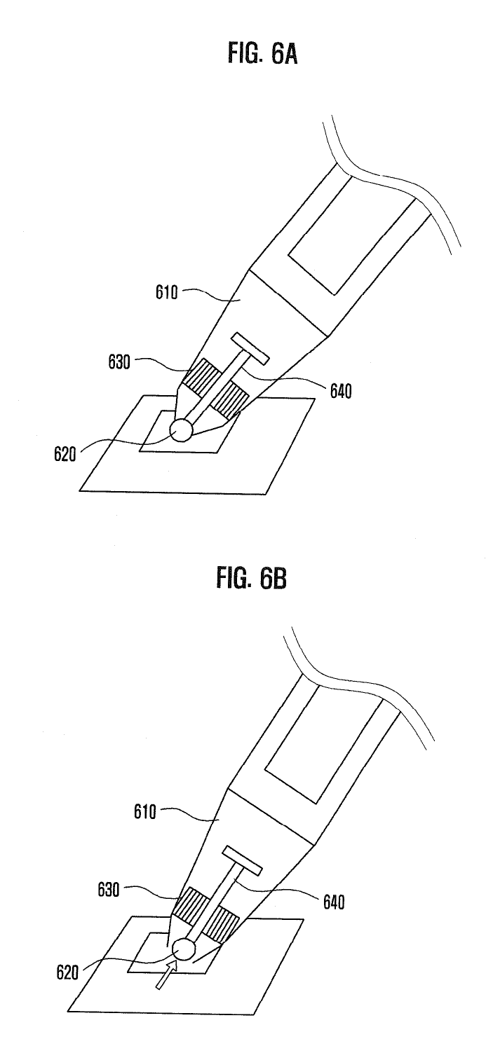

FIGS. 6A and 6B show the vibration generation device of the input device in accordance with an embodiment of the present invention and show a principle that the vibration is generated. The vibration generation device is positioned at a header part 610 of the input device and can be realized as a general vibration device as well as a small ultrasonic linier motor, solenoid and voice coil. When the linear motor is used, the vibration generation device includes a contacting unit 620, a movement guide 630, and a moving axis 640.

The contacting unit 620 contacts the touch screen and moves up and down while contacting. The movement guide 630 connected to the contacting unit moves up and down with the contacting unit. There is a hole in the center of the movement guide 630 and the moving axis is inserted into the hole. The moving axis is fixed without moving and the movement guide moves up and down on the basis of the moving axis.

According to another embodiment, the movement guide 630 is fixed and the moving axis 640 moves in order to raise efficiency of a space. The contacting unit 620 contacts the touch screen and moves up and down. The moving axis 640 connected to the contacting unit moves up and down with the contacting unit. The movement guide 630 is fixed and the moving axis is inserted into the hole in the center. The movement guide is fixed and guides the movement of the moving axis.

According to the embodiment, the contacting unit may move up and down without an additional structure. Also, the voice coil motor or the solenoid may be used as a driving device having a similar structure to generate an operation of the contacting unit. When the user presses a button on touch screen, the contacting unit 620 realizes a feeling of pressing an actual button while instantly moving to an opposite direction of the contact through this driving principle. When vibration is transmitted to the entire input device through the vibration of the contacting unit or a fast reciprocating motion and a frictional force with a contact surface is varied, the user can sense a feeling such as actually writing or drawing.

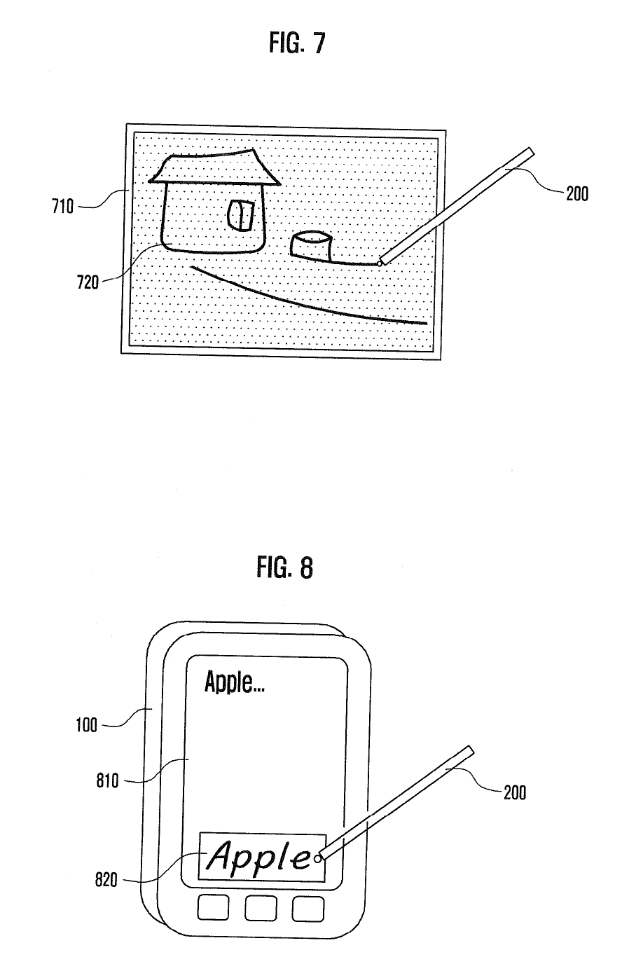

FIG. 7 shows a picture input screen in accordance with an embodiment of the present invention. The user can draw a picture 720 on a touch screen 710 by using the input device 200 and tactile sense, acoustic sense and olfactory sense according to the input mode are created by the sensation effect creating unit 220.

FIG. 8 shows a letter input screen in accordance with an embodiment of the present invention. When a motion is sensed in a letter input region 820 on touch screen 810 of the display device 100, the control unit automatically recognizes a letter or a shape through the motion information. Therefore, tactile sense, acoustic sense and olfactory sense corresponding to the motion information are created by the sensation effect creating unit. For example, when the motion information is recognized as a letter or a shape of an apple, the fragrance emitting module 550 of the sensation effect creating unit 220 emits a apple favor.

As described above, when the user writes or draws on display device embedded with a touch screen by using the input device, the present invention can create reality by stimulating tactile sense, acoustic sense and olfactory sense and improve usefulness of the display device. Therefore, when the system and the device of the present invention are applied to a program for education or learning and curing programs for the old as well as writing or drawing, it is possible to lead active participation of the user and raise efficiency of learning and curing. Furthermore, when the system and device of the present invention are applied to kiosk or a game program, reality can be raised.

While the present invention has been described with respect to the specific embodiments, it will be apparent to those skilled in the art that various changes and modifications may be made without departing from the spirit and scope of the invention as defined in the following claims.

What is claimed is:

1. An input device for a display device with a touch screen, comprising:
a sensation effect creating unit for creating sensation effect based on motion information of the input device;
a communication unit for communicating with the display device;
a control unit for creating sensation effect through the sensation effect creating unit when the motion information of the input device and sensation effect data according to an input mode are transmitted from the display device through the communication unit.

2. The input device of claim 1, wherein the input mode is a kind of writing instruments.

3. The input device of claim 1, wherein the input mode is a quality of a material for a background image of the input screen in the display device.

4. The input device of claim 1, wherein the sensation effect data include tactile sense data providing tactile sense generated when contacting a surface having a predetermined quality of a material with a predetermined instrument set up as the input mode.

5. The input device of claim 1, wherein the sensation effect data include acoustic sense data providing a sound generated when contacting a surface having a predetermined quality of a material with a predetermined instrument set up as the input mode.

6. The input device of claim 1, wherein the sensation effect data include olfactory sense data providing a unique fragrance of a predetermined instrument or a predetermined background quality of a material set up as the input mode, or a specific fragrance that a motion of the input device means.

7. The input device of claim 1, wherein the sensation effect creating unit located in a head part of the input device includes:
a contacting unit for contacting a touch screen and moving up and down while contacting;
a movement guide for moving up and down by being connected to the contacting unit and having a hole in a center; and
a vibration generation device having a moving axis which is fixed after passing through the hole of the movement guide.

8. The input device of claim 1, wherein the sensation effect creating unit located in a head part of the input device includes:
a contacting unit for contacting a touch screen and moving up and down while contacting;
a movement axis for moving up and down by being connected to the contacting unit; and
a vibration generation device having a movement guide which is fixed at a lower part of the contacting unit and guides movement of the movement axis passing through the hole in the center.

9. The input device of claim 1, wherein the sensation effect creating unit includes a skin stimulating pin which is formed of a plurality of pins capable of moving up and down and provides a tactile sense corresponding to the input mode according to the motion of the input device.

10. The input device of claim 1, wherein the sensation effect creating unit includes a speaker providing a sound generated when a predetermined instrument contacts a surface having a predetermined quality of a material according to the motion of the input device.

11. The input device of claim 1, wherein the sensation effect creating unit includes a fragrance emitting module providing a unique fragrance of a predetermined instrument or a predetermined background quality of a material, or a specific fragrance that the motion of the input device means.

12. The input device of claim 1, further comprising:
a memory for storing sensation effect data according to the input mode of the input device.

13. The input device of claim 12, wherein the control unit reads the sensation effect data according to the input mode in the memory and creates sensation effect through the sensation effect creating unit.

14. A display device including a touch screen with an input device providing a user with a sensation effect, comprising:
a memory for storing sensation effect data according to an input mode of the input device;
a communication unit for communicating with the input device; and
a control unit for reading the sensation effect data in the memory on motion information of the input device when the input mode is set up and transmitting the sensation effect data to the input device through the communication unit.

15. The display device of claim 14, wherein the input mode is a kind of writing instruments.

16. The display device of claim 14, wherein the input mode has a background image quality of the input screen of the display.

17. The display device of claim 14, wherein the sensation effect data include tactile sense data providing a tactile sense generated when a predetermined instrument set up as the input mode contacts a surface having a predetermined quality of a material.

18. The display device of claim 14, wherein the sensation effect data include acoustic sense data providing a sound generated when the predetermined instrument set up as the input mode contacts the surface having a predetermined quality of a material.

19. The display device of claim 14, wherein when the motion of the input device means a specific fragrance, the sensation effect data include olfactory sense data emitting the fragrance.

20. The display device of claim 14, further comprising:
a sensation effect creating unit for creating sensation effect according to the motion of the input device.

21. The display device of claim 20, wherein the control unit creates sensation effect through the sensation effect creating unit according to the motion of the input device.

22. The display device of claim 21, wherein the sensation effect creating unit includes a speaker providing a sound generated when a predetermined instrument contacts a surface having a predetermined quality of a material according to the motion of the input device.

23. The display device of claim 21, wherein when the motion of the input device means a specific fragrance, the sensation effect creating unit includes the fragrance emitting module emitting a fragrance.

24. A system for providing a user with a sensation effect, comprising:
an input device, including:
a sensation effect creating unit for creating sensation effect based on motion information of the input device;
a communication unit for communicating with a display device; and
a control unit creating sensation effect through the sensation effect creating unit when the motion information of the input device and the sensation effect data according to the input mode are transmitted from the display device through the communication unit, and
a display device, including:
a memory for storing sensation effect data according to an input mode of the input device;
a communication unit for communicating with the input device; and
a control unit for reading sensation effect data in the memory when the input mode is set up, and transmitting the sensation effect data to input device through the communication unit.
